(19) United States
(12) Patent Application Publication
(10) Pub. No.: US 2015/0014405 A1
(43) Pub. Date: Jan. 15, 2015

(54) TAGGED CELLULOSE ESTER FILMS

(71) Applicant: Celanese Acetate LLC, Irving, TX (US)

(72) Inventors: Raymond M. Robertson, Blacksburg, VA (US); David Nyy, Irving, TX (US)

(73) Assignee: Celanese Acetate LLC, Irving, TX (US)

(21) Appl. No.: 14/322,035

(22) Filed: Jul. 2, 2014

Related U.S. Application Data
(60) Provisional application No. 61/845,645, filed on Jul. 12, 2013.

(51) Int. Cl. G01N 21/64; B29D 7/01; B65D 5/42; B29C 39/00

(52) U.S. Cl. CPC G01N 21/64; B29C 39/003; B29D 7/01; B65D 5/4204; B29L 2007/00
USPC 229/162.1; 252/408.1; 252/301.36; 252/301.34; 264/299; 428/220

(57) ABSTRACT

Cellulose ester films may include taggants to provide for product authentication and counterfeit identification, especially in packaging applications. In some instances, a tagged cellulose ester film may include cellulose ester, a plasticizer, and a taggant, wherein the taggant comprises at least one taggant component selected from the group consisting of an elemental marker, a molecular fluorophore, a particulate fluorophore, and any combination thereof.

### BACKGROUND

The present invention relates to cellulose ester film that comprise taggants to provide for product authentication and counterfeit identification.

Counterfeiting and forgery are among the greatest concerns in the consumer marketplace and the modern global economy. The International Chamber of Commerce estimates that counterfeiting accounts for about 5% to about 7% of world trade, which is about $600 billion annually.

Cellulose ester films are used in a plurality of packaging materials (e.g., thermoformed packaging, clear plastic windows in packages, and the like). Package anti-counterfeiting measures have been included holograms and inscriptions to provide for product authentication. However, the cost for reverse engineering and producing these anti-counterfeiting measures has decreased over the past decade, which makes these anti-counterfeiting measures less effective deterrents. Further, these measures are typically utilized as additions to the packaging rather than incorporating directly into the packaging, which further reduces the cost to counterfeiters. Accordingly, a need exists for anti-counterfeiting measures that are more costly to reverse engineer and reproduce, while keeping the cost to product manufactures low.

### SUMMARY OF THE INVENTION

The present invention relates to cellulose ester film that comprise taggants to provide for product authentication and counterfeit identification.

One embodiment described herein is a tagged cellulose ester film that includes cellulose ester, a plasticizer, and a taggant, wherein the taggant comprises at least one taggant component selected from the group consisting of an elemental marker, a molecular fluorophore, a particulate fluorophore, and any combination thereof.

Another embodiment described herein is a method that includes preparing a dope that comprises cellulose ester, a plasticizer, a solvent, and a taggant, wherein the taggant comprises at least one taggant component selected from the group consisting of an elemental marker, a molecular fluorophore, a particulate fluorophore, and any combination thereof; and casting the dope into a tagged cellulose ester film.

Yet another embodiment described herein is a method that includes preparing a dope that comprises cellulose ester, plasticizer, and a solvent; casting the dope into a cellulose ester film; and applying a taggant to the cellulose ester film to yield a tagged cellulose ester film.

Another embodiment described herein is a method that includes laminating at least two cellulose ester films together, wherein at least one of the cellulose ester films is a tagged cellulose ester film that comprises cellulose ester, a plasticizer, and a taggant, wherein the taggant comprises at least one taggant component selected from the group consisting of an elemental marker, a molecular fluorophore, a particulate fluorophore, and any combination thereof, and wherein optionally at least one of the cellulose ester films is a second tagged cellulose ester film that comprises a second cellulose ester, a second plasticizer, and a second taggant, wherein the taggant and the second taggant are different.

The features and advantages of the present invention will be readily apparent to those skilled in the art upon a reading of the description of the preferred embodiments that follows.

### DETAILED DESCRIPTION

The present invention relates to cellulose ester film that comprise taggants to provide for product authentication and counterfeit identification.

As used herein, the term “taggant” refers to an innocuous additive with a unique signature that identifies the product (e.g., the packaging or a portion of the packaging).

As described herein, the tagged cellulose ester films describe herein provide for an avenue to incorporate anti-counterfeiting measures into packaging. Further, the anti-counterfeiting measures described herein may be integrated into the cellulose ester film production methods, thereby mitigating additional cost of the tagged cellulose ester films. Therefore, the overall cost increase of the packaging produced therefrom may be minimal.

Further, the tagged cellulose ester films described herein may rely on one or more features for authentication including, but not limited to, (1) composition of the taggant as confirmed by fluorescence, elemental analysis, and the like, (2) the relative concentration of individual taggant components, and (3) location of individual taggants including any specific designs or text from printing. Because of the countless permutations and combinations of these features, the reverse engineering of the tagged cellulose ester films becomes more difficult and costly, provides for robust anti-counterfeiting measures.

It should be noted that when “about” is provided herein in reference to a number in a numerical list, the term “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

A tagged cellulose ester film described herein may, in some embodiments, comprise cellulose ester, a plasticizer, and a taggant.

As used herein, the term “cellulose ester” encompasses both cellulose diester and cellulose triester compositions. As used herein, the term “cellulose diester” refers to cellulose derivatized with ester moieties with a degree of substitution of about 2.2 to about 2.7. As used herein, the term “cellulose triester” refers to cellulose derivatized with ester moieties with a degree of substitution of greater than about 2.7 up to about 3.

Suitable cellulose esters for use as described herein may include, but are not limited to, cellulose diacetate, cellulose dibutyrate, cellulose dipropionate, cellulose di(acetate butyrate), cellulose di(acetate propionate), cellulose di(butyrate propionate), cellulose di(acetate butyrate propionate), cellulose triacetate, cellulose tributyrate, cellulose tripropionate, cellulose tri(acetate butyrate), cellulose tri(acetate propionate), cellulose tri(butyrate propionate), cellulose tri(acetate butyrate propionate), and the like, and any combination thereof.

Plasticizers may be useful in tailoring the softness and flexibility of the tagged cellulose ester film. Suitable plasticizers for use as described herein may include, but are not limited to, glycerol triacetate (triacetin), triethyl citrate, dimethoxy-ethyl phthalate, dimethyl phthalate, diethyl phthalate, methyl phthalyl ethyl glycolate, o-phenyl phenyl-(bis) phenyl phosphate, 1,4-butanediol diester, diester, dipropionate ester of triethylene glycol, dibutyrate ester of triethylene glycol, dimethoxyethyl phthalate, triethyl citrate, triacetyl glycerin, and the like, any derivative thereof, and any combination thereof.

In some embodiments, plasticizers may be included in the tagged cellulose ester films described herein in an amount ranging from a lower limit of about 15%, 20%, or 23% by weight of the tagged cellulose ester film to an upper limit of about 30%, 25%, or 20% by weight of the tagged cellulose ester film, wherein the amount may range from any lower limit to any upper limit and encompasses any subset therebetween.

In some embodiments, taggants may comprise one or more taggant components. Suitable taggant components may include elemental markers, molecular fluorophores, particulate fluorophores, and the like, or a combination thereof. One skilled in the art, with the benefit of this disclosure, should recognize the appropriate considerations when choosing taggant components. For example, when the tagged cellulose ester films is produced for use in conjunction with food packaging, the taggant components should be chosen so as to conform with any regulations for food-safe packaging.

As used herein, the term “elemental markers” refers to taggant components that can be identified via elemental analysis (e.g., inductively coupled plasma-atomic emission (“ICP-AE”) spectroscopy, inductively coupled plasma-mass spectroscopy (“ICP-MS”), and the like). Elemental markers may include elements not present in other portions of the tagged cellulose ester films (e.g., titanium, vanadium, chromium, iron, cobalt, nickel, copper, zinc, aluminum, silicon, zirconium, molybdenum, palladium, silver, gold, tin, tungsten, platinum, erbium, gadolinium, and the like). In some instances, depending on the other additives described herein, elemental markers comprising titanium or silicon may not be preferred as titania and silica can be additives used for other purposes in cellulose ester films, tagged or otherwise.

Elemental markers may be in the form of molecules (e.g., gold salts), polymers (e.g., silicone polymers or polymers with copper or other suitable ion chelated thereto), or particulates (e.g., microparticles (about 500 nm to about 250 microns in at least one dimension) or nanoparticles (about 0.5 nm to less than about 500 nm in at least one dimension)).

Generally, fluorophores have an excitation wavelength and emission wavelength. This combination can be used to identify different taggant components that are fluorescent.

Molecular fluorophores may include fluorescent molecules, polymers derivatized with fluorescent molecules, and the like, and any combination thereof. Examples of fluorescent molecules may include acridine dyes, cyanine dyes, fluorine dyes, oxazin dyes, phenanthridine dyes, rhodamine dyes, and the like, and any combination thereof. Examples of polymers suitable for fluorophore derivatization may include, but are not limited to, polyvinypyrrolidone, polyacrylic acid, polyacrylamide, polymethacrylamides, polyamine, polyethyleneimine, and the like. Suitable polymers may also be copolymers comprising monomeric units corresponding at least one of the foregoing polymers. As used herein, the term “copolymer” encompasses polymers with two or more monomeric units, (e.g., alternating copolymers, statistic copolymers, random copolymers, periodic copolymers, block copolymer (e.g., diblock, triblock, and so on), terpolymers, graft copolymers, branched copolymers, star polymers, and the like, or any hybrid thereof).

Examples of particulate fluorophores may include fluorescent nanoparticles (e.g., having a diameter (or at least one dimension) being about 1 nm to about 500 nm) like metal nanoparticles (e.g., gold, silver, platinum, palladium, cobalt, zinc, nickel, tin, and the like, and alloys thereof like gold silver nanoparticles), metal oxide nanoparticles (e.g., silica nanoparticles, titania nanoparticles, iron oxide nanoparticles, zinc oxide nanoparticles, iron zinc oxide nanoparticles, and the like), magnetic nanoparticles (e.g., iron oxide nanoparticles, iron cobalt nanoparticles, and the like), quantum dots (e.g., cadmium selenide nanoparticles, cadmium sulfide nanoparticles, cadmium telluride nanoparticles, indium arsenide nanoparticles, and indium phosphide nanoparticles, and the like), carbon nanoparticles (e.g., single-walled carbon nanotubes, double walled carbon nanotubes, graphene oxide, graphene oxide ribbons, and the like), and any combination thereof.

Another example of particulate fluorophores may include core-shell nanoparticles wherein at least the shell is nano-dimensional. As used herein, the term “core-shell” refers to particles having a core material with at least one shell disposed thereabout (including less than 100% coverage). It should be noted that the term “core-shell” encompasses multiple shells, sometimes referred to as onionated nanoparticles. In some embodiments, a core-shell nanoparticle may comprise a metal oxide or quantum dot core and at least one nano-thick layer (e.g., about 0.5 nm to about 150 nm), wherein the nano-thick layer comprises a metal oxide, a metal, and the like (e.g., a quantum dot described herein, a silica, titania, zinc oxide, or iron oxide core with at least one shell comprising gold, silver, platinum, cobalt, silica, and the like).

By way of nonlimiting example, the taggant may comprise 3 nm gold particles, 10 nm gold particles, and 25 nm gold particles with relative concentrations of 1:5:2 such that the fluorophore particles in combination with the concentration provide for three emission peaks of varying height at a given excitation wavelength. By way of another nonlimiting example, a taggant may comprise a molecular fluorophore and a particulate fluorophore such that at a first excitation wavelength the molecular fluorophore emits a first emission wavelength and the particulate fluorophore has no emission and at a second excitation wavelength the particulate fluorophore emits a second emission wavelength and the molecular fluorophore has no emission.

In some embodiments, the tagged cellulose ester films described herein may comprise taggant in an amount ranging from a lower limit of about 0.0005 wt %, 0.005 wt %, 0.01 wt %, 0.5 wt %, or 1 wt % of the tagged cellulose ester films to an upper limit of about 10 wt %, 5 wt %, or 1 wt % of the tagged cellulose ester films, and wherein the amount of active particles can range from any lower limit to any upper limit and encompass any subset therebetween. It should be noted that concentrations outside these preferred ranges may be useful. For example, taggant components with high emission efficiencies may be at lower concentrations.

In some embodiments, the tagged cellulose ester film may further comprise additives. Suitable additives may include, but are not limited to, colorants, opacity additives, deterioration inhibitors (e.g., antioxidants), degradation agents (e.g., UV degradable compounds), conductivity modifying agents, flame retardants, thermal stabilizers, aromas, flavorants, biocides, antifungals, antimicrobials, antistatic agents, and the like, and any combination thereof.

In some embodiments, the tagged cellulose ester films described herein may be produced by casting methods. Some embodiments may involve preparing a dope that comprises cellulose ester, a plasticizer, a solvent, and a taggant; and casting the dope into a tagged cellulose ester film. Some embodiments may involve preparing a dope that comprises cellulose ester, plasticizer, and a solvent; casting the dope into a cellulose ester film; and applying the taggant to the cellulose ester film to yield a tagged cellulose ester film. Some embodiments may involve a hybrid of the two where a first taggant component is included in the dope and a second taggant component is applied after casting the dope.

Examples of suitable solvents may include, but are not limited to, acetone, ethyl acetate, butanone, dichloromethane, methanol, water, and the like, and any combination thereof.

In some embodiments, casting a tagged cellulose ester film may involve passing a dope comprising cellulose ester, a plasticizer, a solvent, and a taggant through an extruder onto a surface to form a pre-film; and drying the pre-film to form the tagged cellulose ester film. In some embodiments, casting a tagged cellulose ester film may involve passing a dope comprising cellulose ester, a plasticizer, and a solvent through an extruder onto a surface to form a pre-film; drying the pre-film to form a cellulose ester film; and applying a taggant to the pre-film, the cellulose ester film or both to yield a tagged cellulose ester film. Some embodiments may involve a hybrid of the two where a first taggant component is included in the dope and a second taggant component is applied after passing the dope through the extruder.

In some embodiments, casting may further include a second drying step to reduce the solvent content and moisture content in the tagged cellulose ester film to desired levels. In some preferred embodiments, casting may yield a tagged cellulose ester film with a thickness of about 75 microns, 100 microns, or 125 microns to about 200 microns, 175 microns, or 150 microns, and wherein the thickness may range from any lower limit to any upper limit and encompasses any subset therebetween. One of ordinary skill in the art should recognize that thickness outside these ranges may be achieved.

In some embodiments, cellulose ester film described herein may be produced by extrusion methods. Some embodiments may involve mixing cellulose ester, a plasticizer, and a taggant; and applying heat and pressure to the mixture to yield a tagged cellulose ester film. In some embodiments, cellulose ester film described herein may be produced by extrusion methods. Some embodiments may involve mixing cellulose ester and a plasticizer; applying heat and pressure to the mixture to yield a cellulose ester film; and applying the taggant to the cellulose ester film to yield a tagged cellulose ester film. Some embodiments may involve a hybrid of the two where a first taggant component is included before applying heat and pressure, and a second taggant component is applied after applying heat and pressure.

In some preferred embodiments, tagged cellulose ester films produced by extrusion methods may be produced at a thickness of about 20 microns, 50 microns, or 100 microns to about 2 mm, 1 mm, 500 microns, or 250 microns, and wherein the thickness may range from any lower limit to any upper limit and encompasses any subset therebetween. One of ordinary skill in the art should recognize that thickness outside these ranges may be achieved.

In some embodiments, two or more tagged cellulose ester films may be laminated together to yield the desired thickness. Lamination may allow for concentrating the taggant in the interior of the final tagged cellulose ester film. For example, a tagged cellulose ester film produced with a taggant or taggant component disposed on one side may be laminated to a similar tagged cellulose ester film such that sides with the taggant or taggant component are touching. The tagged cellulose ester film produced after lamination may have the taggant or taggant component primarily in the middle of the cross-section of the tagged cellulose ester film. In some instances, the same or different taggant or taggant component may be utilized on the two or more tagged cellulose ester films. One skilled in the art with the benefit of this disclosure should recognize that laminating may extend to a plurality of other configuration (e.g., three or more taggants layered, stripes of taggants, and the like).

Some embodiments for authenticating a tagged cellulose ester film described herein may involve irradiating at least a portion of the tagged cellulose ester film with at least one excitation spectrum ranging from ultraviolet to infrared, so as to yield an emission spectrum corresponding to the tagged cellulose ester film; and observing and comparing the emission spectrum to a reference emission spectrum corresponding to a reference tagged cellulose ester film. It should be noted that the term “spectrum” relative to excitation or emission encompasses single wavelengths, multiple independent wavelengths, a continuum of wavelengths, multiple independent continuums of wavelengths, and any combination thereof. For example, multiple independent wavelengths may be 1064 nm, 632 nm, and 515 nm. In another example, a continuum of wavelengths in combination with an independent wavelength may include 450 nm to 725 nm and 1064 nm.

In some instances, the portion of the tagged cellulose ester film mass used for authentication may be the cross-section of the cellulose ester film (e.g., when the layering anti-counterfeiting measures are implemented). In some instances, the portion of the tagged cellulose ester film mass used for authentication may be a ground and optionally washed with a solvent before irradiating.

In some instances, observing may be by eye. In some instances, observing may utilize a spectrometer. In some instances, observing may utilize a spectrometer capable of corresponding emission spectrum with location (e.g., a camera, a microscope, and the like).

In some instances, comparing may involve determining if certain wavelengths of an emission spectrum are present or absent. In some instances, comparing may involve analyzing the intensity and relative intensity (when two or more are present) of certain wavelengths of an emission spectrum. In some instances, comparing may involve comparing the emission spectrum and location thereof of the tagged cellulose ester film to the reference tagged cellulose ester film (e.g., when a design is utilized as part of the anti-counterfeiting measures).

Some embodiments for authenticating tagged cellulose ester films described herein may involve taking a sample from at least a portion of the tagged cellulose ester film; analyzing the sample for elemental composition; and comparing the elemental composition to a reference elemental composition corresponding to a reference tagged cellulose ester film. Some embodiments for authenticating tagged cellulose ester film described herein may involve taking at least two samples from different portions of the tagged cellulose ester film; analyzing the samples for elemental composition; and comparing the elemental composition and location of the samples to a reference tagged cellulose ester film (e.g., when a design is utilized as part of the anti-counterfeiting measures).

The tagged cellulose ester films described herein may be useful in packaging. For example, a packaging may comprise a tagged cellulose ester film described herein thermoformed into a desired shape. In another example, a packaging may comprise a box (e.g., a cardboard box) that has a window that is formed at least in part by a tagged cellulose ester film described herein.

Embodiments disclosed herein include:

A. a tagged cellulose ester film that includes cellulose ester, a plasticizer, and a taggant, wherein the taggant comprises at least one taggant component selected from the group consisting of an elemental marker, a molecular fluorophore, a particulate fluorophore, and any combination thereof;

B. a method that includes preparing a dope that comprises cellulose ester, a plasticizer, a solvent, and a taggant, wherein the taggant comprises at least one taggant component selected from the group consisting of an elemental marker, a molecular fluorophore, a particulate fluorophore, and any combination thereof; and casting the dope into a tagged cellulose ester film;

C. a method that includes preparing a dope that comprises cellulose ester, plasticizer, and a solvent; casting the dope into a cellulose ester film; and applying a taggant to the cellulose ester film to yield a tagged cellulose ester film; and

D. a method that includes laminating at least two cellulose ester films together, wherein at least one of the cellulose ester films is a tagged cellulose ester film that comprises cellulose ester, a plasticizer, and a taggant, wherein the taggant comprises at least one taggant component selected from the group consisting of an elemental marker, a molecular fluorophore, a particulate fluorophore, and any combination thereof, and wherein optionally at least one of the cellulose ester films is a second tagged cellulose ester film that comprises a second cellulose ester, a second plasticizer, and a second taggant, wherein the taggant and the second taggant are different.

Each of embodiments A, B, C and D may have one or more of the following additional elements in any combination: Element 1: the cellulose ester comprising at least one selected from the group consisting of cellulose diacetate, cellulose dibutyrate, cellulose dipropionate, cellulose di(acetate butyrate), cellulose di(acetate propionate), cellulose di(butyrate propionate), cellulose di(acetate butyrate propionate), cellulose triacetate, cellulose tributyrate, cellulose tripropionate, cellulose tri(acetate butyrate), cellulose tri(acetate propionate), cellulose tri(butyrate propionate), cellulose tri(acetate butyrate propionate), and any combination thereof; Element 2: the plasticizer comprising at least one selected from the group consisting of glycerol triacetate (triacetin), triethyl citrate, dimethoxy-ethyl phthalate, dimethyl phthalate, diethyl phthalate, methyl phthalyl ethyl glycolate, o-phenyl phenyl-(bis) phenyl phosphate, 1,4-butanediol diester, diester, dipropionate ester of triethylene glycol, dibutyrate ester of triethylene glycol, dimethoxyethyl phthalate, triethyl citrate, triacetyl glycerin, any derivative thereof, and any combination thereof; Element 3: the plasticizer being present in an amount of about 15% to about 30% by weight of the tagged cellulose ester film; Element 4: the taggant being present in an amount of about 0.005 wt % to about 10 wt % by weight of the tagged cellulose ester film; Element 5: the tagged cellulose ester film further comprising at least one additive selected from the group consisting of a colorant, an opacity additive, a deterioration inhibitors, a degradation agent, a conductivity modifying agent, a flame retardant, a thermal stabilizer, an aroma, a flavorant, a biocide, an antifungal, an antimicrobial, an antistatic agent, and any combination thereof; and Element 6: the tagged cellulose ester film having a thickness of about 20 microns to about 2 mm (including subsets thereof).

By way of non-limiting example, exemplary combinations applicable to Embodiments A, B, C and D include: Element 1 in combination with at least one of Elements 2-4; Element 2 in combination with at least one of Elements 3 and 4; Element 3 in combination with Element 4; Element 5 in combination with any of the foregoing; Element 6 in combination with any of the foregoing; and so on.

Additional embodiments described herein may include (Embodiment E) a packaging that includes a tagged cellulose ester film according to or produced according to any of the foregoing embodiments (optionally with Elements as described herein) that is thermoformed into a desired shape; (Embodiment F) a packaging that includes a box that has a window that is formed at least in part by a tagged cellulose ester film according to or produced according to any of the foregoing embodiments (optionally with Elements as described herein).

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A tagged cellulose ester film comprising cellulose ester, a plasticizer, and a taggant, wherein the taggant comprises one or more taggant components selected from the group consisting of elemental markers, molecular fluorophores, particulate fluorophores, and any combination thereof.

2. The tagged cellulose ester film of claim 1, wherein the cellulose ester comprises at least one selected from the group consisting of cellulose diacetate, cellulose dibutyrate, cellulose dipropionate, cellulose di(acetate butyrate), cellulose di(acetate propionate), cellulose di(butyrate propionate), cellulose di(acetate butyrate propionate), cellulose triacetate, cellulose tributyrate, cellulose tripropionate, cellulose tri(acetate butyrate), cellulose tri(acetate propionate), cellulose tri(butyrate propionate), cellulose tri(acetate butyrate propionate), and any combination thereof.

3. The tagged cellulose ester film of claim 1, wherein the plasticizer comprises at least one selected from the group consisting of glycerol triacetate (triacetin), triethyl citrate, dimethoxy-ethyl phthalate, dimethyl phthalate, diethyl phthalate, methyl phthalyl ethyl glycolate, o-phenyl phenyl-(bis) phenyl phosphate, 1,4-butanediol diester, diester, dipropionate ester of triethylene glycol, dibutyrate ester of triethylene glycol, dimethoxyethyl phthalate, triethyl citrate, triacetyl glycerin, any derivative thereof, and any combination thereof.

4. The tagged cellulose ester film of claim 1, wherein the plasticizer is present in an amount of about 15% to about 30% by weight of the tagged cellulose ester film.

5. The tagged cellulose ester film of claim 1, wherein the taggant is present in an amount of about 0.005 wt % to about 10 wt % by weight of the tagged cellulose ester film.

6. The tagged cellulose ester film of claim 1 further comprising at least one additive selected from the group consisting of a colorant, an opacity additive, a deterioration inhibitors, a degradation agent, a conductivity modifying agent, a flame retardant, a thermal stabilizer, an aroma, a flavorant, a biocide, an antifungal, an antimicrobial, an antistatic agent, and any combination thereof.

7. The tagged cellulose ester film of claim 1, wherein the tagged cellulose ester film has a thickness of about 20 microns to about 2 mm.

8. A packaging comprising the tagged cellulose ester film of claim 1 that is thermoformed into a desired shape.

9. A packaging comprising a box that has a window formed at least in part by the tagged cellulose ester film according to claim 1.

10. A method comprising:
preparing a dope that comprises cellulose ester, a plasticizer, a solvent, and a taggant, wherein the taggant comprises one or more taggant components selected from the group consisting of elemental markers, molecular fluorophores, particulate fluorophores, and any combination thereof; and
casting the dope into a tagged cellulose ester film.

11. The method of claim 10, wherein the cellulose ester comprises at least one selected from the group consisting of cellulose diacetate, cellulose dibutyrate, cellulose dipropionate, cellulose di(acetate butyrate), cellulose di(acetate propionate), cellulose di(butyrate propionate), cellulose di(acetate butyrate propionate), cellulose triacetate, cellulose tributyrate, cellulose tripropionate, cellulose tri(acetate butyrate), cellulose tri(acetate propionate), cellulose tri(butyrate propionate), cellulose tri(acetate butyrate propionate), and any combination thereof.

12. The method of claim 10, wherein the plasticizer comprises at least one selected from the group consisting of glycerol triacetate (triacetin), triethyl citrate, dimethoxy-ethyl phthalate, dimethyl phthalate, diethyl phthalate, methyl phthalyl ethyl glycolate, o-phenyl phenyl-(bis) phenyl phosphate, 1,4-butanediol diester, diester, dipropionate ester of triethylene glycol, dibutyrate ester of triethylene glycol, dimethoxyethyl phthalate, triethyl citrate, triacetyl glycerin, any derivative thereof, and any combination thereof.

13. The method of claim 10, wherein the plasticizer is present in an amount of about 15% to about 30% by weight of the tagged cellulose ester film.

14. The method of claim 10, wherein the taggant is present in an amount of about 0.005 wt % to about 10 wt % by weight of the tagged cellulose ester film.

15. The method of claim 10, wherein the tagged cellulose ester film has a thickness of about 20 microns to about 2 mm.

16. A method comprising:
preparing a dope that comprises cellulose ester, plasticizer, and a solvent;
casting the dope into a cellulose ester film; and
applying a taggant to the cellulose ester film to yield a tagged cellulose ester film, wherein the taggant comprises one or more taggant components selected from the group consisting of elemental markers, molecular fluorophores, particulate fluorophores, and any combination thereof.

17. The method of claim 16, wherein the plasticizer comprises at least one selected from the group consisting of glycerol triacetate (triacetin), triethyl citrate, dimethoxy-ethyl phthalate, dimethyl phthalate, diethyl phthalate, methyl phthalyl ethyl glycolate, o-phenyl phenyl-(bis) phenyl phosphate, 1,4-butanediol diester, diester, dipropionate ester of triethylene glycol, dibutyrate ester of triethylene glycol, dimethoxyethyl phthalate, triethyl citrate, triacetyl glycerin, any derivative thereof, and any combination thereof.

18. The method of claim 16, wherein the plasticizer is present in an amount of about 15% to about 30% by weight of the tagged cellulose ester film.

19. The method of claim 16, wherein the taggant is present in an amount of about 0.005 wt % to about 10 wt % by weight of the tagged cellulose ester film.

20. The method of claim 16, wherein the tagged cellulose ester film has a thickness of about 20 microns to about 2 mm.
